(19) United States
(12) Patent Application Publication
(10) Pub. No.: US 2025/0331464 A1
(43) Pub. Date: Oct. 30, 2025

(54) ASPIRATION SYSTEM FOR AGRICULTURAL VEHICLE

(71) Applicant: CNH Industrial America LLC, New Holland, PA (US)

(72) Inventors: Cale Boriack, New Holland, PA (US); Nathan Isaac, Lancaster, PA (US)

(73) Assignee: CNH Industrial America LLC, New Holland, PA (US)

(21) Appl. No.: 18/647,594

(22) Filed: Apr. 26, 2024

(51) Int. Cl. A01F 12/48; A01F 12/44

(52) U.S. Cl. CPC A01F 12/48; A01F 12/444; A01F 12/446; A01F 2009/00

(57) ABSTRACT

An agricultural vehicle, in the form of a combine harvester, includes a threshing and separating system and a cleaning system positioned beneath the threshing and separating system for receiving grain processed by the threshing and separating system. The cleaning system includes a first fan and sieves positioned downstream of a discharge outlet of the first fan. The sieves are positioned such that a stream of air produced by the first fan passes over the sieves. The vehicle also includes a housing having a hollow interior space that is positioned at least partially downstream of the first fan such that the stream of air passes into the hollow interior space. A second fan has a suction side that is in fluid communication with the interior space and a discharge side that exhausts to atmosphere for aspirating the interior space to reduce an air pressure within the interior space.

### FIELD OF THE INVENTION

The present invention relates to agricultural vehicles, such as a combine harvester. More specifically, the present invention relates to an aspiration system for reducing the pressure within a straw hood of a combine harvester.

### BACKGROUND OF THE INVENTION

As is described in U.S. Patent App. Pub. No. 2023/0086794 to CNH America LLC (the '794 Publication), which is incorporated by reference in its entirety and for all purposes, an agricultural harvester known as a “combine” is historically termed such because it combines multiple harvesting functions with a single harvesting unit, such as picking, threshing, separating and cleaning. The separating system of the combine directs the non-grain material (otherwise referred to as material other than grain or MOG) to a residue system. The residue system distributes the non-grain material through a chopper, a spreader, and/or a windrow chute before it is distributed onto the field.

Excessive pressure in the cleaning and residue handling systems may result in reduced fan efficiency, feeder back-feeding, and dust aspiration out of the feeder. As harvesters and their internal systems increase in size, more airflow is required to separate the chaff from the grain. This increased airflow is met with increased internal pressure within the straw hood of the harvester.

It would be desirable to reduce the internal pressure within the straw hood of the harvester.

### SUMMARY OF THE INVENTION

According to one aspect of the invention, an agricultural vehicle, which may be in the form of a combine harvester, includes a threshing and separating system and a cleaning system positioned beneath the threshing and separating system for receiving grain processed by the threshing and separating system. The cleaning system includes a first fan and sieves positioned downstream of a discharge outlet of the first fan. The sieves are positioned such that a stream of air produced by the first fan passes over the sieves. The vehicle also includes a housing having a hollow interior space that is positioned at least partially downstream of the first fan such that the stream of air passes into the hollow interior space. A second fan has a suction side that is in fluid communication with the interior space and a discharge side that exhausts to atmosphere for aspirating the interior space to reduce an air pressure within the interior space.

### BRIEF DESCRIPTION OF THE DRAWINGS

The above-mentioned and other features and advantages of this invention, and the manner of attaining them, will become more apparent and the invention will be better understood by reference to the following description of an embodiment of the invention taken in conjunction with the accompanying drawings, wherein:

FIG. 1 is a side view of an embodiment of an agricultural harvester in the form of a combine illustrating the residue handling system of the present invention in a cutout view toward the rear of the harvester;

FIG. 2 is a simplified side view of the threshing and residue handling system of the combine of FIG. 1, wherein the residue handling system has an aspiration system according to a first example;

FIG. 3 is a simplified side view of the threshing and residue handling system of the combine of FIG. 1, wherein the residue handling system has an aspiration system according to a second example;

FIG. 4 is a simplified side view of the threshing and residue handling system of the combine of FIG. 1, wherein the residue handling system has an aspiration system according to a third example; and

FIG. 5 is a top plan view of the aspiration system of FIG. 4.

It is noted that the figures depict features and elements in schematic form and are not necessarily to scale.

### DETAILED DESCRIPTION OF THE INVENTION

Corresponding reference characters indicate corresponding parts throughout the several views. Inasmuch as various components and features of harvesters are of well-known design, construction, and operation to those skilled in the art, the details of such components and their operations will not generally be discussed in significant detail unless considered of pertinence to the present invention or desirable for purposes of better understanding.

In the drawings, like numerals refer to like items, certain elements and features may be labeled or marked on a representative basis without each like element or feature necessarily being individually shown, labeled, or marked, and certain elements are labeled and marked in only some, but not all, of the drawing figures.

The terms “grain”, “chaff”, “straw”, and “tailings” are used principally throughout this specification for convenience but it is to be understood that these terms are not intended to be limiting. Thus “grain” refers to that part of the crop material that is threshed and separated from the discardable part of the crop material, which is referred to as chaff or material other than grain (MOG) and includes straw, seeds, and other non-grain crop material.

Also the terms “forward”, “rearward”, “left” and “right”, when used in connection with the agricultural harvester and/or components thereof are usually determined with reference to the direction of forward operative travel of the harvester, but again, they should not be construed as limiting. The terms “longitudinal” and “transverse” are determined with reference to the fore-and-aft direction of the agricultural harvester and are equally not to be construed as limiting. The terms “upstream” and “downstream” are determined with reference to the crop flow stream.

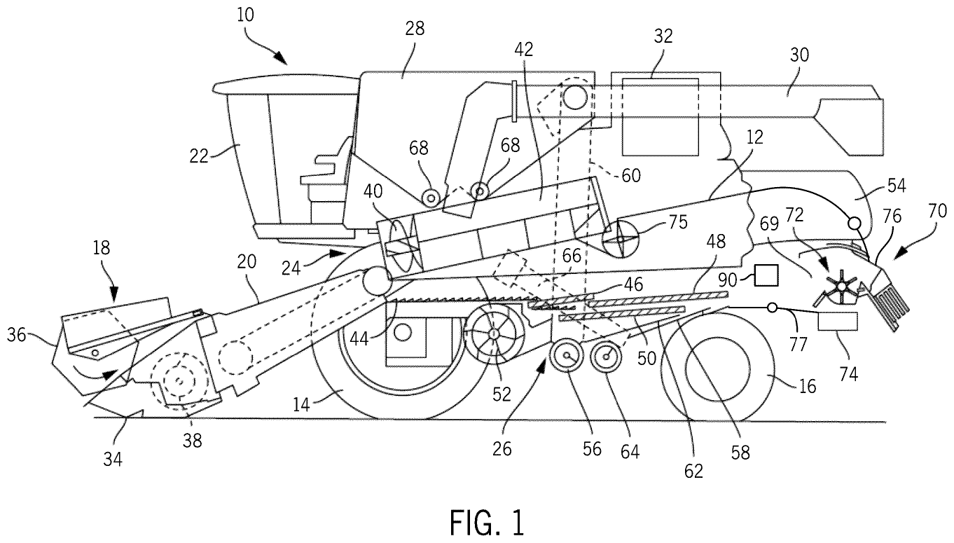

Referring now to the drawings, and more particularly to FIG. 1, there is shown an agricultural harvester in the form of a combine 10, which generally includes a chassis 12, ground engaging wheels 14 and 16, a header 18, a feeder housing 20, an operator cab 22, a threshing and separating system 24, a cleaning system 26, a grain tank 28, and an unloading conveyance 30. Motive force is selectively applied to the front wheels 14 through a power plant in the form of a diesel engine 32 and a transmission (not shown). Both the front and rear wheels 14 and 16 may be steerable.

The header 18 is mounted to the front of the combine 10 and includes a cutter bar 34 for severing crops from a field during forward motion of combine 10. A rotatable reel 36 feeds the crop into the header 18, and a double auger 38 feeds the severed crop laterally inwardly from each side toward the feeder housing 20. The feeder housing 20 conveys the cut crop to threshing and the separating system 24.

The threshing and separating system 24 generally includes a rotor 40 at least partially enclosed by and rotatable within a corresponding perforated concave 42. The cut crops are threshed and separated by the rotation of the rotor 40 within the concave 42, and larger elements, such as stalks, leaves and the like are discharged from the rear of the combine 10. Smaller elements of crop material including grain and non-grain crop material, including particles lighter than grain, such as chaff, dust and straw, are discharged through perforations of the concave 42. It should be understood that system 24 can vary and is not limited to that which is shown and described.

Grain that has been separated by the threshing and separating assembly 24 falls onto a grain pan 44 and is conveyed toward the cleaning system 26. The cleaning system 26 may include an optional pre-cleaning sieve 46, an upper sieve 48 (also known as a chaffer sieve), a lower sieve 50 (also known as a cleaning sieve), and a cleaning fan 52. Each sieve may be mounted to a reciprocating shoe, as known in the art. Grain on the sieves 46, 48 and 50 is subjected to a cleaning action by the fan 52, which provides an airflow through the sieves, to remove chaff and other impurities such as dust from the grain by making this material airborne for discharge from the straw hood 54 of the combine 10. The grain pan 44 and the pre-cleaning sieve 46 oscillate in a fore-to-aft manner to transport the grain and finer non-grain crop material to the upper surface of the upper sieve 48. The upper sieve 48 and the lower sieve 50 are vertically arranged relative to each other, and likewise oscillate in a fore-to-aft manner to spread the grain across sieves 48, 50, while permitting the passage of cleaned grain by gravity through the openings of sieves 48, 50. It should be understood that system 26 can vary and is not limited to that which is shown and described.

Clean grain falls to a clean grain auger 56 positioned crosswise below and in front of the lower sieve 50. The clean grain auger 56 receives clean grain from each sieve 48, 50 and from bottom pan 58 of the cleaning system 26. The clean grain auger 56 conveys the clean grain laterally to a generally vertically arranged grain elevator 60 for transport to the grain tank 28. Tailings from the cleaning system 26 fall to a tailings auger trough 62. The tailings are transported via tailings auger 64 and the return auger 66 to the upstream end of the cleaning system 26 for repeated cleaning action. The cross augers 68 at the bottom of the grain tank 28 convey the clean grain within the grain tank 28 to the unloading auger 30 for discharge from the combine 10.

Although a rotary combine has been described thus far, it should be understood that the details presented herein are not limited to rotary combine and may be applicable to other machines, such as conventional combines and cross harvester combines.

A residue handling system 70 is integrated in the rear of harvester 10. Residue handling system 70 generally comprises a straw hood 54 defining a hollow interior space, a discharge beater 75, a chopper 72, horizontally oriented spreaders 74 (one shown), a pivotable flap 77 that may be used to prevent the passage of residue into spreader 74, and an aspiration system 90 that are all at least partially positioned within straw hood 54. It should be understood that the system 70 is not limited to any one of the aforementioned components.

Straw and residue choppers 72 and residue spreaders 74 of various types and constructions have long been in use in or with such residue treatment and distribution systems. Each chopper 72 may have a housing 72a, a rotor 72b having blades extending therefrom that is positioned within housing 72a, an inlet of the housing 72a for receiving MOG and an outlet of the housing through which the chopped MOG is distributed to the spreader 74. Similarly, each spreader 74 may have a housing 74a, a rotor 74b having flails extending therefrom that is positioned within housing 74a, and an outlet 74c of the housing 74a through which chopped MOG is distributed onto a field below the combine. Such choppers and spreaders have operated to chop or pulverize the crop residue resulting from a harvesting operation into finer pieces and/or to spread the resulting crop residue, whether chopped into finer pieces by operation of a chopper assembly or passed to the spreader assembly as larger pieces of residue, onto and over the field. Further details in connection with choppers and spreaders may be found in U.S. Pat. No. 7,553,225, which is incorporated by reference herein in its entirety.

Referring now to various individual components of residue handling system 70, straw hood 54 includes opposing side walls that are connected to a top wall. The walls together define an interior space, which is also referred to herein as a passageway 69 for straw and chaff.

Chopper 72 is configured to rotate and chop the straw material and (optionally) deliver it to spreader 74. A windrow mode selection door 76 is mounted to the top wall of straw hood 54 at a location above the chopper 72. Door 76 pivots between two positions, namely, a deployed position and a retracted position (shown in FIG. 1). In the retracted position of door 76 shown in FIG. 1, the door 76 prevents the stream of residue from passing through the windrow outlet formed in the straw hood 54, and, the stream is directed to the residue chopper 72. In the deployed position, the stream of residue (straw), which is discharged from the discharge beater 75, is diverted over top of the chopper 72, through the windrow outlet of the machine 10 and onto a hood or chute that guides the residue to form a windrow behind the machine 10.

As noted in the background section, excessive pressure in the cleaning and residue handling systems may result in reduced efficiency of fan 52, back-feeding in feeder 20, and dust aspiration out of the feeder 20. As harvesters and their internal systems increase in size, more airflow by fan 52 is required to separate the chaff from the grain. This increased airflow is met with increased internal pressure within the passageway 69 of straw hood 54 of the harvester.

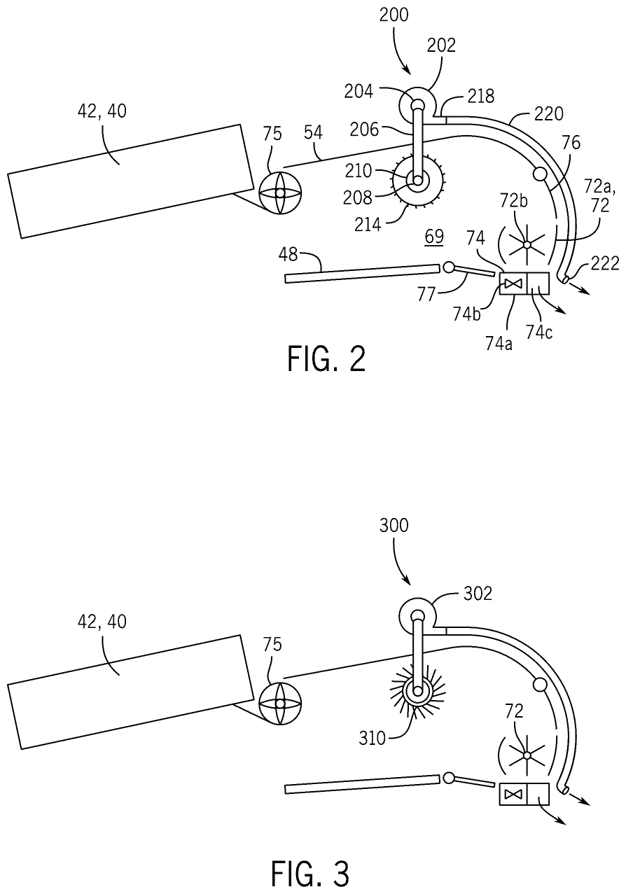

For at least those reasons, combine 10 includes an aspiration system 90 that communicates with the passageway 69 of the straw hood 54 to reduce the internal pressure within the passageway 69 of straw hood 54. As will be described with reference to the various examples shown in FIGS. 2-5, the aspiration system 90 generally includes one or more fans having an inlet (also referred to as a suction side) that communicates with the passageway 69 to reduce the pressure therewithin and an outlet (also referred to as a discharge side or pressure side) that directs the exhausted air at or near the outlet of the residue spreader(s) 74 in order to assist with the discharge of residue from spreader(s) 74 or block any side wind streams present in the vicinity of spreader(s) 74. Different variants of the aspiration system are described hereinafter.

According to the first example of the aspiration system, the aspiration system 200 of FIG. 2 includes at least one fan 202 that is (optionally) positioned outside of the passageway 69 of straw hood 54. The fan 202 includes an inlet end 204 that is fluidly coupled to one end of a conduit 206. A fluid connection is intended to mean a connection that permits the transport of air, fluid, etc. The opposite end of conduit 206 is fluidly coupled to an inlet port 208 of a duct 210. The duct 210 may be a cylinder, for example, that extends transversely within passageway 69. The duct 210 extends at least a portion of the distance between the side walls of straw hood 54. Alternatively, duct 210 may extend across the entire distance between the side walls of straw hood. The revolved surface of duct 210 may be perforated to permit the entrance of air into the interior of duct 210. Alternatively, the revolved surface of duct 210 may be solid, and the opposite end of duct 210 that is positioned within passageway 69 may be open to receive air from the passageway 69. The revolved exterior surface of the duct 210 may be covered by (and positioned within) a cylindrical screen 214 having a perforated surface. The small tabs extending radially from the screen 214 constitute the perforated surface. The screen 214 may be rotatable, as indicated by the arrow.

A pulley may be fixed to one end of screen 214 to enable rotation of the screen 214 about the longitudinal axis of the screen 214. In assembled form, the pulley may be connected to a driven belt of combine 10. That driven belt may also be connected to a drive shaft of the chopper 72, fan 202, beater 75, and/or spreader 74. It is noted that the screen 214 would rotate at a slower speed (e.g., 50-100 rpm) as compared with the rotation speed of the fan shaft (e.g., 3600 rpm). Alternatively, a rotatable shaft extending from the screen 214 may be driven to rotate by a separate hydraulic pump, hydraulic motor, or electrical motor, for example.

It should be understood that the air within passageway 69 is delivered through the screen 214, into the duct 210 and then into the inlet port of the fan 202. Drawing a vacuum or partial vacuum within passageway 69 assists in reducing the interior pressure within passageway 69. The air from passageway 69 is delivered through the outlet port 218 of fan 202, and into a conduit 220 having a first end that is fluidly connected to the outlet port 218 of fan 202. The conduit 220 (optionally) extends outside of straw hood 54. The second end 222 of conduit 220 is positioned to deliver the exhausted air at or near the outlet of spreader 74 in order to assist with the discharge of residue from spreader 74 or block any side wind streams present in the vicinity of spreader 74. The streams emanating from spreader 74 and conduit 220 are designated by arrows in FIG. 2. Although only one fan 202 and one duct 210 connected to that fan 202 are shown in the example of FIG. 2, it should be understood that a plurality of fans and ducts may be incorporated into straw hood 54.

Turning now to the second example of the aspiration system, the aspiration system 300 of FIG. 3 has a fan 302 and is substantially similar to the system 200 of FIG. 2 with the exception that (i) the revolved surface of duct 310 is perforated to receive air through those perforations, (ii) the duct 310 has a pulley at one end that is connected to a driven belt of the combine to cause rotation of duct 310 about its longitudinal axis (like the pulley attached to screen 214), and (iii) the duct 310 is not covered by a separate screen (like screen 214). It should be understood that other ways exist for causing rotation of duct 310.

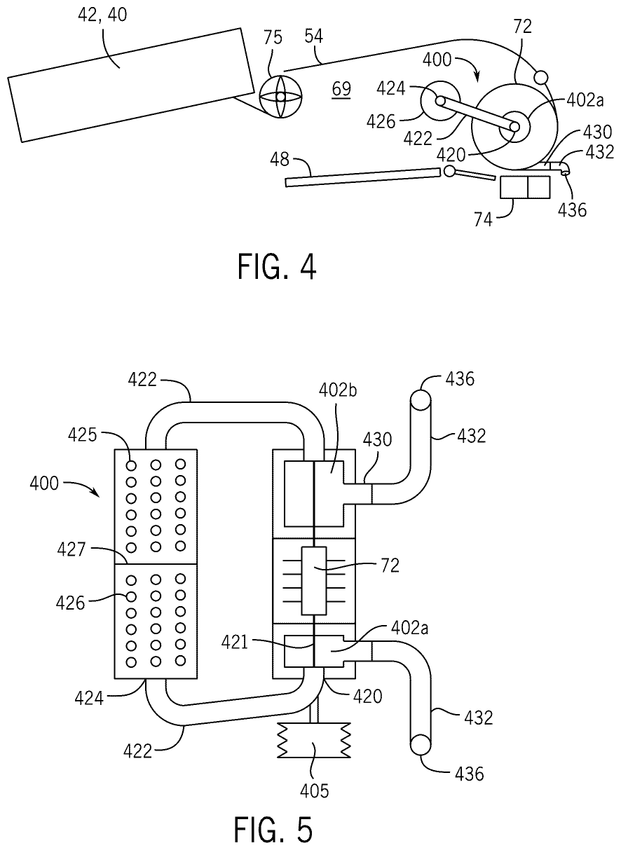

Turning now to the third example of the aspiration system, the aspiration system 400 of FIGS. 4 and 5 is substantially similar to the system 200 of FIGS. 2 and 3, and the differences will be described hereinafter. Aspiration system 400 includes two fans 402a and 402b (referred to collectively or individually as fan(s) 402) each having a rotatable shaft that is non-rotatably connected to a rotatable shaft of chopper 72. Those shafts may be said to be co-aligned, aligned, continuous, or concentric to form a common shaft 421. Alternatively, the shafts may also be misaligned, if so desired.

Chopper 72 and the fans 402 may be arranged in a row that extends transversely within straw hood 54, as shown. The chopper 72 and fans 402 may be positioned within a common housing, as shown. Interior dividers separate the interior region of that common housing into three separate regions each sized for accommodating one of the chopper 72 and fans 402a and 402b. The shafts of chopper 72 and fans 402a, 402b form a common shaft 421 having one end that may be connected to a pulley 405 that is driven by a driven belt of the combine that is wound about the pulley 405. The pulley 405 is omitted in FIG. 4.

Each fan 402a, 402b has an inlet end 420 that is fluidly coupled to one end of a conduit 422. The inlet of each fan 402 may be aligned (as shown) or offset from the axis of the common shaft 421. The opposite end of conduit 422 is fluidly coupled to a port 424 of a duct 426. The duct 426 may be a hollow tube, for example, that extends transversely within passageway 69. The duct 426 may extend at least a portion of the distance between the side walls of straw hood 54. The revolved surface of duct 426 may have openings or perforations 425, as shown, to permit the passage of air thereinto. The duct 426 may include an interior divider 427 that separates the interior into two different chambers, wherein each fan 402 is fluidly connected to one of those two chambers. The revolved exterior surface of the duct 426 may be covered by (and positioned within) a cylindrical screen having a perforated surface. The duct 426 and/or its screen may be rotatable as was previously described. Drawing a vacuum or partial vacuum within passageway 69 assists in reducing the interior pressure within passageway 69.

For each fan 402, the air from passageway 69 is delivered through the outlet port 430 of fan 402, and into a conduit 432 having a first end that is fluidly connected to the outlet port 430 of fan 402. The conduit 432 (optionally) extends outside of straw hood 54. The second end 436 of conduit 432 is positioned to deliver the exhausted air at or near the outlet of spreader 74 for the reasons described above. It is noted that conduits 422 and 432 may extend either inside or outside of straw hood 54.

As noted above, aspiration system 400 includes fans 402a and 402b (referred to collectively or individually as fan(s) 402) each having a rotatable shaft that is non-rotatably connected to a rotatable shaft of chopper 72. As an alternative to receiving power from the chopper 72, the fans could receive power from the spreaders 74. Each fan would have a rotatable shaft that is non-rotatably connected to a rotatable shaft of one of the spreaders 74. Each fan could be positioned either above or beneath its spreader 74. The inlet of each fan would be connected to a duct (like duct 426) via a conduit (like conduit 422), and the outlet of each fan could be connected to a conduit (like conduit 436) or a passage within one of the spreaders.

As another alternative, instead of employing fans, each spreader could have two different impellers disposed within different chambers, like that disclosed in U.S. Pat. No. 10,398,081, which is incorporated by reference in its entirety, whereby one of the impellers would be responsible for the delivery of chopped crop material onto the ground and the other impeller would be fluidly connected to a duct (like duct 426) via a conduit (like conduit 422) for reducing the pressure within passageway 69 and delivering a stream of air into the stream of chopped crop material. The impellers could be powered hydraulically, electrically or by a mechanical belt drive (for example) and operated at different speeds.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. An agricultural vehicle comprising:
a threshing and separating system;
a cleaning system positioned beneath the threshing and separating system for receiving grain processed by the threshing and separating system, the cleaning system comprising a first fan and one or more sieves positioned downstream of a discharge outlet of the first fan, wherein the one or more sieves are positioned such that a stream of air produced by the first fan passes over the one or more sieves;
a housing having a hollow interior space that is positioned at least partially downstream of the first fan such that the stream of air passes into the hollow interior space; and
a second fan having a suction side that is in fluid communication with the interior space and a discharge side that exhausts to atmosphere for aspirating the interior space to reduce an air pressure within the interior space.

2. The agricultural vehicle of claim 1 further comprising a chopper positioned within the interior space of the housing to receive material other than grain (MOG) processed by the threshing and separating system, the chopper having (i) a chopper rotor having blades or flails depending therefrom, and (ii) a chopper housing at least partially surrounding the chopper rotor, the chopper rotor and chopper housing together being configured to process the MOG into chopped MOG.

3. The agricultural vehicle of claim 2 further comprising a spreader positioned at or near an outlet of the chopper for receiving the chopped MOG from the chopper, the spreader having (i) a spreader rotor having blades or flails depending therefrom, and (ii) a spreader housing at least partially surrounding the spreader rotor, the spreader rotor and spreader housing together being configured to spread the chopped MOG onto a field beneath the agricultural vehicle.

4. The agricultural vehicle of claim 3, wherein the discharge side of the second fan is connected to a first end of a first conduit, the first conduit also having a second end that is positioned to deliver the stream of air such that the stream of air is combined with a stream of the chopped material that is expelled through an outlet opening of the spreader.

5. The agricultural vehicle of claim 1, wherein the suction side of the second fan is connected to a first end of a second conduit, the second conduit also having a second end that is connected to a duct that is at least partially positioned within the housing.

6. The agricultural vehicle of claim 5, wherein the duct extends transversely through the housing.

7. The agricultural vehicle of claim 6, wherein the duct has one or more openings through which air in the housing is distributed.

8. The agricultural vehicle of claim 6, wherein the duct includes a perforated surface through which air in the housing is distributed.

9. The agricultural vehicle of claim 6, wherein the duct is configured to rotate about a longitudinal axis thereof.

10. The agricultural vehicle of claim 6, wherein the duct is covered by a perforated screen.

11. The agricultural vehicle of claim 10, wherein the perforated screen is configured to rotate about a longitudinal axis thereof, while the duct is static.

12. The agricultural vehicle of claim 1 further comprising a chopper positioned within the interior space of the housing to receive material other than grain (MOG) processed by the threshing and separating system, the chopper having (i) a chopper rotor having blades or flails depending therefrom, and (ii) a chopper housing at least partially surrounding the chopper rotor, the chopper rotor and chopper housing together being configured to process the MOG into chopped MOG,
wherein the second fan comprises a second fan rotor that is non-rotatably connected to the chopper rotor,
wherein the suction side of the second fan is connected to a first end of a second conduit, the second conduit also having a second end that is connected to a duct that is at least partially positioned within the housing.

13. The agricultural vehicle of claim 12, further comprising a third fan having a suction side that is in fluid communication with the interior space and a discharge side that is positioned outside of the housing for aspirating the interior space to reduce an air pressure within the interior space,
wherein the third fan comprises a third fan rotor that is non-rotatably connected to the chopper rotor,
wherein the suction side of the third fan is connected to a first end of a third conduit, the third conduit also having a second end that is connected to the duct that is at least partially positioned within the housing.

14. The agricultural vehicle of claim 1, wherein the agricultural vehicle is a combine harvester.

15. The agricultural vehicle of claim 14, wherein the threshing and separating system comprises a threshing rotor that is at least partially surrounded by a concave.
